(19) United States
(12) Patent Application Publication
(10) Pub. No.: US 2009/0134004 A1
(43) Pub. Date: May 28, 2009

(54) Driving or driven distiller with heat pump function

(76) Inventor: William J. Asprey, Hoquiam, WA (US)

Correspondence Address: William J. Asprey, 516 10th Street, Hoquiam, WA, 98550, US

(21) Appl. No.: 12/313,966

(22) Filed: Nov. 26, 2008

Related U.S. Application Data
(60) Provisional application No. 61/004,364, filed on Nov. 27, 2007.

(51) Int. Cl. B01D 3/30; B01D 3/14; B01D 3/08

(52) U.S. Cl. 202/174; 202/238; 202/235

(57) ABSTRACT

This invention improves efficiencies of existing distilling devices and provides the opportunity to utilize latent heat for heating or cooling purposes. Sufficient heat sources or cooling sinks can drive the invention for mechanical power production. The innovative use of an elongated chamber hydraulic column positive pressure at the bottom to drive condensation; and pertaining negative pressure in a sealed volume at the top to evince evaporation give a new capability. Repeated mechanical inversions of the chamber allows the evaporated vapor volumes to be compressed and driven to condense by the fluid hydraulic column as a piston, eliminating requirements for seals. This allows operation with many fluid separations and in many physical environmental regimes, both internal to the elongated chamber and externally. Inverting the chamber uses or produces power efficiently in force fields such as gravity, centrifugal, or linear inertial yielding possibilities for miniaturization and extension of output parameters and throughputs.

### BACKGROUND OF THE INVENTION

1. Field of Invention

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

This invention relates to distillation systems, specifically to those using less or different applications of energy than common practice to achieve separations.

Class Definition for Class 202—DISTILLATION: APPARATUS as defined by the USPTO fits this invention well as it is directly related to separating two mixed fluids by phase change encouraged by thermal and pressure variations.

CLASS 203, DISTILLATION: PROCESSES, SEPARATORY is also generally applicable to this invention due to the variable nature of the inputs, throughputs, and outputs viably treated with this device operable with serial stages for fractional distillations.

Also, CLASS 44, FUEL AND RELATED COMPOSITIONS relates to this invention in that the thermal and pressure regimes extend to the realms of fuels separations by variable distillations.

CLASS 208, MINERAL OILS: PROCESSES AND PRODUCTS also fits this designation for the same reasons.

In addition, CLASS 62, REFRIGERATION is referable due to the desirable aspect of this invention to cause the cooling effects attendant to latent heat removal from the distilland whether use is made of the vapor withdrawn or not.

CLASS 422, CHEMICAL APPARATUS AND PROCESS DISINFECTING, DEODORIZING, PRESERVING, OR STERILIZING discovers the desired endpoint of sterilization which is obtainable by this invention due to the inherent isolation and environmental variability.

CLASS 261, GAS AND LIQUID CONTACT APPARATUS describes aspects of this invention by keying on the vapor evolution from distilland, transport and condensation.

2. Description of Prior Art

The need to separate different materials in mixtures, solutions, and combinations is widely recognized. Further, the need to effect such separations with minimal energy input has recently become more important with the greater costs associated with prime mover energy and greater equipment expenses.

The earliest historical separations were done in ancient Assyria to create ‘air water’ for the King by distilling water in a boiler, with vapor flow upwards into an upper chamber for condensation. Large amounts of heat were required to gain very little water by this.

Rainfall was later recognized to be a natural, large-scale distillation of sea and surface waters which then condensed and rained down as relatively pure water. Very large surface areas of water exposed to sunlight are required for significant rainfall due to the very diffuse nature of sun energy.

Many attempts have been made by inventors to improve thermal and separation efficiencies, throughputs, costs, and lifetimes of distiller designs. The US Navy has used vacuum distillation of seawater for decades to allow production of drinking water at lower temperatures. This avoids attendant spoiling of boilers with sulfate and carbonate depositions due to thermal cycling of the seawater from normal atmospheric boiling and concentration followed by cooling. There are high costs associated with production, maintenance, and containment of vacuum environments by these methods.

A recognition of these limitations and the requirements of large scale industry has led to several notable improvements such as staged distillation utilizing several temperature and pressure regimes to reuse latent heat energy over several stages, vacuum distillation utilizing reduced pressure to increase evaporation, and fractional distillation for separation of multiple materials in mixtures and solutions.

Vacuum distillation is utilized industrially to separate high boiling substances by inducing evaporation at a lower temperature by reducing the environmental pressure to below that of the azeotrophic boiling point as in vacuum centrifugal and rotary distillation systems. These systems can be continuous or batch processes although they all suffer from problems of complexity, thermal energy waste, and high material costs.

These improvements all continue to use heat as the driving force for evaporation with various schemes for returning or reusing latent heat for further evaporation. The disadvantages of driving the entire process with heat are that:
(a) The inherent losses due to entropy make these approaches inherently inefficient uses of heat. The fact that all of the vapor is formed and then condensed at the same pressure creates necessary temperature differentials to be maintained with external mechanisms. Also, these temperatures are generally elevated in relation to the environment and so must be maintained against environmental as well as latent heat losses.
(b) The inability of existing devices to provide distillation and heat pumping in a consolidated unit limits the desirability of applications.
(c) The application to power production unitized with distillate outputs in a simple and low cost device is lacking with current practice.
(d) The material and financial costs of these approaches are very high due to high or low pressures and corrosive environments. The evaporating and condensing environments are large to accommodate productivity and they suffer from stresses due to the temperatures, pressures, and corrosive natures of many materials to be separated.
(e) The fractional distillation systems also suffer from the need to heat the entire quantity to vapor and then progressively condense lower vapor pressure materials out at a range of temperatures. This undesirable over-heating of the bulk of the materials, including the carrier fluids, is of necessity wasted or at best used at a lower quality.
(f) Carry over of supply fluids is a problem with many attempts to solve with baffles, cyclones (U.S. Pat. No. 4,622,103 Shirley-Elgood, et al. Nov. 11, 1986), and material impingement filters. These increase the costs, complexity and unreliability of these devices.
(g) The direct application of mechanical energy to elicit latent energy evaporation and condensation serially is theoretically much more efficient than using heat to drive it.

In vacuum distillation there have been attempts to purify water while heat pump devices feed latent heat deposited in condensers back into evaporators to augment efficiencies with relatively higher evaporator temperatures and so higher rates and smaller surface areas for evaporation. The problem remains that the external heat pump cycle simply magnifies the thermal transport driving the process to produce more distillate faster while using additional energy.

There are patents using hydraulic suction and pressure with open bottom chambers oscillating up and down in open bodies of water (such as U.S. Pat. No. 4,954,223 by Leary, et al, Sep. 4, 1990). This fails to use the hydraulic coupling of the fluid column between the two chambers and eliminates the opportunity to seal the systems.

### SUMMARY

In accordance with the invention disclosed herein an elongated chamber filled with a fluid acting as a piston alternately lifting and falling causing or caused by evaporation and condensation of the distillate product.

### OBJECTS AND ADVANTAGES

Accordingly, besides the objects and advantages of this distilling heat pump described in the complete disclosure, several objects and advantages of the present invention are:
(a) to provide both purification or separation and heat pump capabilities with a single unit;
(b) to provide a distilling function available with power production by providing heat to the evaporator or cooling to the condenser;
(c) to provide variability in the rates of production of distillates or heating or cooling to match loads;
(d) to provide low cost mechanisms for purification or heating and cooling;
(e) to provide inherently energy efficient purification and heating or cooling;
(f) to provide for extremely simple mechanisms within gravity or much more compact rotating units capable of greater rates;
(g) to provide advantages in accurately separating mixtures of a variety of boiling points with several staged units;
(h) to provide sealed unitary structures to maintain isolation of contained materials;
(i) to provide less failure prone devices for reliability;
(j) to provide a greater degree of safety due to low pressures, temperatures, and speeds;
(k) to provide for a fluid forcing surface and hydraulic force transfer with elastic continuity and surface tension allowing transfer of tensile and compressive forces with low friction, self sealing liquid piston operation;
(l) to provide highly accurate and specific separations of constituents as a detection for materials with a specific vapor pressure profile;
(m) to provide high quality purification by repeated application of the distiller or a series thereof.

Further objects and advantages are to provide a system which can provide greater efficiency of heating, cooling, and purification, which is easily sized for distributed application, which can be built with very low cost materials, which is simple enough for anyone to construct or maintain, which can be used in a staged, varying, or repetitive manner to separate complex mixtures, which operates slowly, coolly, and at low pressure for safety, which uses gravity or other imposed force to develop pressures and vacuums by accelerating a fluid column, which can supply heating, cooling, and purified water with the same unit, which can be reversed to produce mechanical power from heat, which can be operated iteratively or slowly to obtain arbitrary levels of purity in the distillate or distilland.

### DRAWING FIGURES

In the drawings each figure indicates a possible conformation of the invention. Many others are possible provided they yield the necessary fluid flows and arrangements within the force fields.

FIG. 1 is a suspended variety of elongated chamber produced with a flexible connecting transfer tube as the body of the elongated chamber.

FIG. 2 is a simple embodiment (as built) of principles for the sealed elongated chamber with hydraulic bubble control and valving to auxiliary condensation and evaporation chambers.

FIG. 3 is a third possible embodiment of principles for the sealed elongated chamber with a piston bubble suppressor and valving to auxiliary condensation and evaporation chambers.

FIG. 4 demonstrates viable modification for engine operation for the device elucidated in either FIG. 2 or FIG. 3.

### REFERENCE NUMERALS IN DRAWINGS

10 sealed elongated chamber

12 condensation chamber

14 evaporation chamber

16 condensation valves

18 evaporation valves

20 transfer tubes

22 rotation axis

24 bubble control piston

30 fixed alternately reversing drive pulley

32 flexible support cable

36 Force field direction (down in gravity field)

40 transfer tube shutoff valve for power production

42 transfer tube used for power production

### DETAILED DESCRIPTION OF THE INVENTION

Herewith is disclosed a mechanical distilling heat pump in which an evacuated sealed elongated chamber is partially filled with degassed fluid. Inversion or reorientation occurs with blocked vapor back flow within a force field such as gravity, rotational inertia, or other force.

This inversion or reorientation can also be driven by thermal energy. Sufficient net pressure in the lower end can force the fluid upward in the force field. The chamber then reorients, falling in the force field while drawing off power. The driving pressure vapor is then drawn off during the rise of the fluid piston during the next reorientation, and so on.

A partial vacuum is produced at the top of the elongated chamber due to hydraulic suction from suspended fluid. An increased pressure is also realized at the bottom of the elongated chamber due to hydraulic force from above. Reversal of the ends of the elongated chamber within the force field yields a reversal of the fluid column height. This causes an increase in pressure in the bottom end of the elongated chamber. A concomitant decrease of the pressure in the now upper end in the elongated chamber. This is due to the force from the accelerated fluid column pulling down.

The partial vacuum or lower pressure at the upper end is ported to a sealed, isolated, and evacuated evaporator. This has a large surface area wet with feed fluid where vapor is evolved.

The increased pressure at the bottom end is ported to a large surface area condenser. It is sealed, isolated, and evacuated. We obtain both separation of the evaporated fluid and also separation of the attendant latent heat. This heat is carried by the vapor transferred from a lower pressure to higher pressure.

Some of the evolved vapor will condense during the compressive inversions of the elongated chamber. The respective surface areas of the evaporator and condenser are much greater than the fluid piston area. The rates of evaporation and condensation depend on the relative surface areas and temperatures. Careful design and rate control produces significant distillate throughput.

The process is easily reversible. Extra heat is given to the evaporator to relatively increase the pressure therein. This positive pressure is connected to the lower end of the sealed elongated chamber. This pressure drives the fluid to the upwards end of the sealed elongated chamber. This now unbalanced end is allowed to fall in gravity or other force field. During this fall we can tap the mechanical power off. This yields pure fluids, mechanical energy output, and lower grade heat into the condenser.

The vapor enclosed must be primarily that which will condense within the condenser. This will avoid turbulent flows, dead space, and functional losses. Build up of incondensable gases must be avoided. These can be removed from the feed fluids before induction to the evaporator. Alternatively these incondensable gases can be removed from the condenser as they accumulate. Removal by pumping or using a second stage of this device as a degassing step is viable.

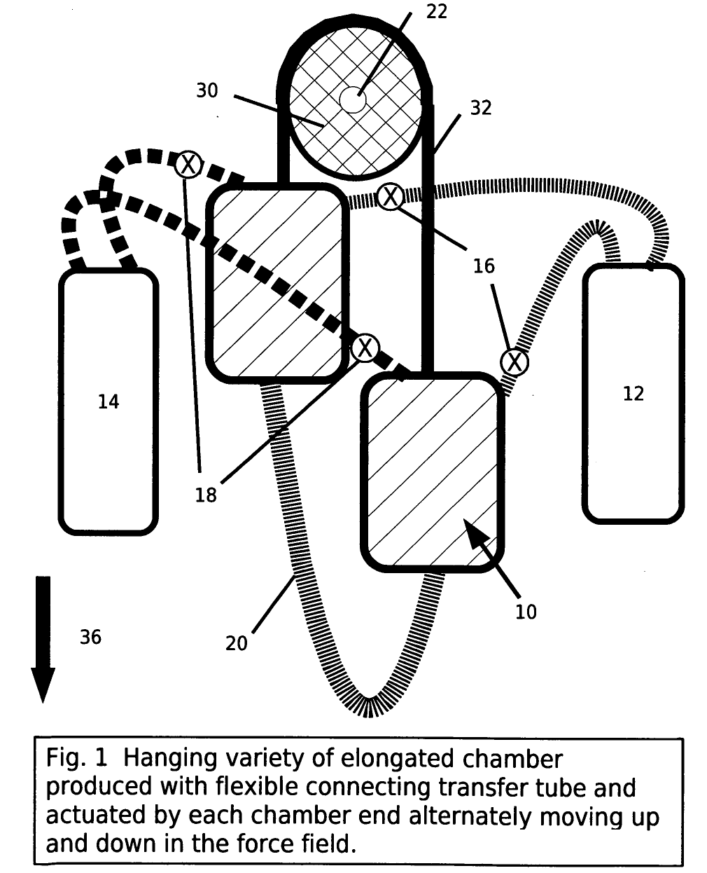

The fluid flow path within the seated elongated chamber may need to vary. The mechanical energy input or output modes of the distiller require different fluid path attributes. The fluids need to drain completely from the upper end during mechanical energy input mode. During the energy output mode the vapor from the evaporator must be fluid locked. This allows the vapor to push the fluid piston upwards against the force gradient. This is obviated in the suspended variety heat pump distiller (FIG. 1). In this the fluid connection is always sealed with the fluid due to the geometry.

The driving of or by the variable potential energy of the fluid within the elongated chamber is used. It provides distilled components of a fluid as well as pumped latent heat. These benefits are accomplished whether mechanical energy is produced or utilized.

The elongated chamber must be structurally capable of sustaining the requisite net pressure or vacuum within. Material selections are depending on liquid characteristics and throughput requirements. The structural design will depend on the vapor pressures at desired operating temperatures. This can require elevated or depressed temperatures, pressures, or physical dimensions. Also, esoteric material choices for solubility and corrosion issues may be necessary.

Included in this disclosure is the application to fractional distillation. Attendant heat pumping and/or mechanical energy generation is included. Multiple elongated chambers are provided in series and/or parallel formations. These with differing operating parameters as the feed fluid is passed along.

Alternatively, a single elongated chamber can be operated with a variable set of input parameters. Variations in temperature, pressure, and physical dimensions allow various feed fluid components to be vaporized at differing times. This allows separations of various components of complex mixtures temporally.

In addition, the input parameters to the elongated chamber can be varied within a consistent fluid environment. This can evince repeated distillation of the same fraction until great purity is obtained.

### Description —FIG. 1—Preferred Embodiment

A preferred embodiment of the distilling heat pump wherein the elongated chamber 10 and the condensation and evaporation chambers 12 and 14 are interconnected and sealed. All chambers and conduits are initially filled with degassed fluid and then evacuated with all valves open to form a pure vapor space within.

This suspended variety of elongated chamber 10 is produced with a flexible connecting transfer tube 20 connecting the two large volume chamber ends. It is actuated by moving each chamber end of the elongated chamber 10 alternately up and down while suspended over the drive pulley 30 in the force field 36.

One chamber end of the elongated chamber 10 is then raised up by the cable 32 and power pulley 30 by the rotation about axis 22. The fluid runs down into the now lower end. All of the valves 16 and 18 are closed.

The opposing end of the elongated chamber 10 is then raised up by the cable 32 and power pulley 30 by the opposite rotation about axis 22. The ends of the elongated chamber 10 are so reversed in positions up and down relative to the impressed force field.

The upper evaporation valve 18 and the lower condensation valve 16 are then opened and the fluid is allowed to drain into the now lower end of the elongated chamber 10, forcing the vapor into the condensation chamber 12 and pulling vapor from the evaporation chamber 14.

Upon completion of the fluid transfer through the transfer tube 20 the valves are again closed. The elongated chamber 10 is again reoriented in the opposite direction raising the lower end and lowering the higher end. This is accomplished by actuating the power pulley 30 in the opposite direction.

The upper evaporation valve 18 and the lower condensation valve 16 are then opened and the fluid is allowed to drain into the now lower end of the elongated chamber 10, forcing the vapor therein into the condensation chamber 12 and pulling further vapor from the evaporation chamber 14 into the upper end of the elongated chamber 10.

This alternating reversal of position of the elongated chamber 10 end for end continues. This functions as long as there is source fluid in the evaporating chamber 14 and it is kept sufficiently warm. Space in the condensing chamber 12 and sufficiently cool conditions there along with power to drive the reorienting elongated chamber 10 is necessary. Sufficient temperatures to allow vapor transports to and from the chambers 12 and 14 must be maintained.

In addition, the feed fluid in the evaporating chamber 14 must be replaced as it concentrates or evaporates and the product distillate must be removed from the condensation chamber 12.

This embodiment allows for heat flow simply through the environment without forced flow. Heat flow can be provided by heat exchange or heat pumping between the condensing chamber 12 and evaporating chamber 14. Removal of sensible heat from the condensing chamber 12 for use and/or provision of heat to the evaporating chamber 16 for cooling purposes is a major gain.

Additional heat to the evaporating chamber 14 can be low grade. This heat can be provided by cooling space or materials or supplied by sources including environmental, geothermal, chemical, electrical, friction, chilling, or others. Excess heat can be wasted to sinks including environmental, geothermal, chemical, electrical, phase change, sensible heat, or others.

To maximize distillate production the latent heat flow into the condensing chamber 12 would be recirculated as efficiently as possible back into the evaporating chamber 14. Otherwise the heater or chiller features can be optimized.

Operation as a heat engine is accomplished simply by heating the evaporating chamber 14 and/or chilling the condensing chamber 12. Also opening the evaporator valve 18 to the elongated chamber 10 end that is down and opening the condenser valve 16 to the elongated chamber 10 end that is up.

This causes the pressure from the evaporating chamber 14 to push up the fluid within the low end of the elongated chamber 10 through the transfer tube 20. This push against the force 36 such as gravity plus the counter pressure of the condensing chamber 12 must be supplied by the pressure in the evaporating chamber 14.

As this fluid accumulates within the higher end of the elongated chamber, the potential energy increases. When the filled upper end of the elongated chamber is allowed to fall, the potential energy can be tapped off from the cable 32 driving the power pulley 30 which drives a useful load such as a generator or machine.

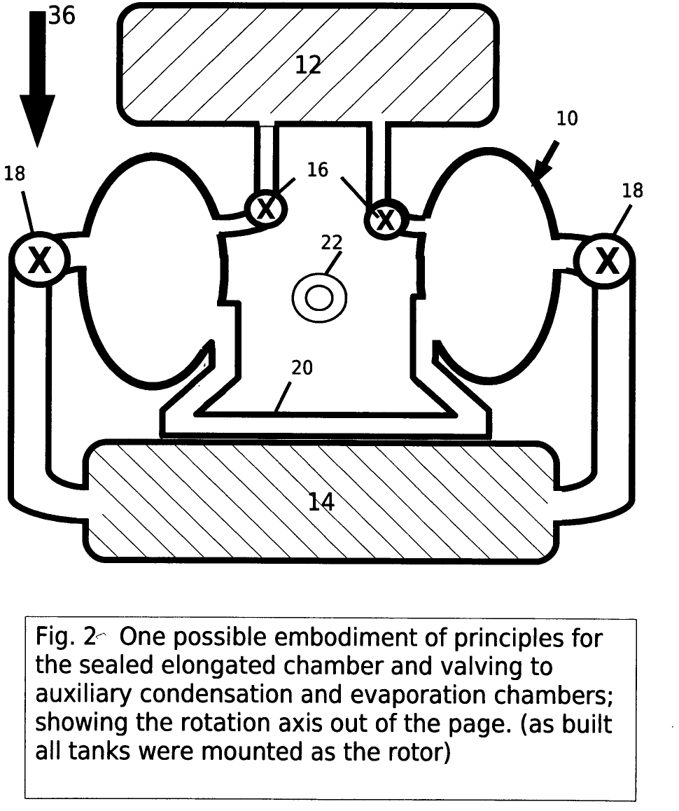

### FIG. 2—Additional Embodiment

The operation of the elongated chamber 10 and valving 16 and 18 is the same as that for FIG. 1. The control of the floating bubble is done hydraulically by impeding vapor flow with the fluid column pressure. This rocks like a teeter totter rotating about the axis 22.

The valving mimics that of previous embodiments wherein the condensing valves 16 are open only whilst in the lower positions and the evaporator valves 18 are open only whilst in the upper positions.

Modifications to make the fluid flow upward by pressure from the evaporating chamber 14 during operation as an engine can be made. One method would be to valve off (not shown) the existing transfer tube 20 when engine operation is prescribed. Then open a valve in an alternate transfer tube (not shown) which sources in the extreme ends of the elongated chamber 10.

This then forces the fluid to move into the transfer tube and upward when excess vapor pressure from the evaporating chamber 14 is valved into the lower end of the elongated chamber 20 to drive the fluid up.

The mechanical energy is taken off when the raised fluid forces the raised end of the elongated chamber 10 downward. So torque is produced at the rotation axis 22 to be taken off to power a useful load such as a generator or machine.

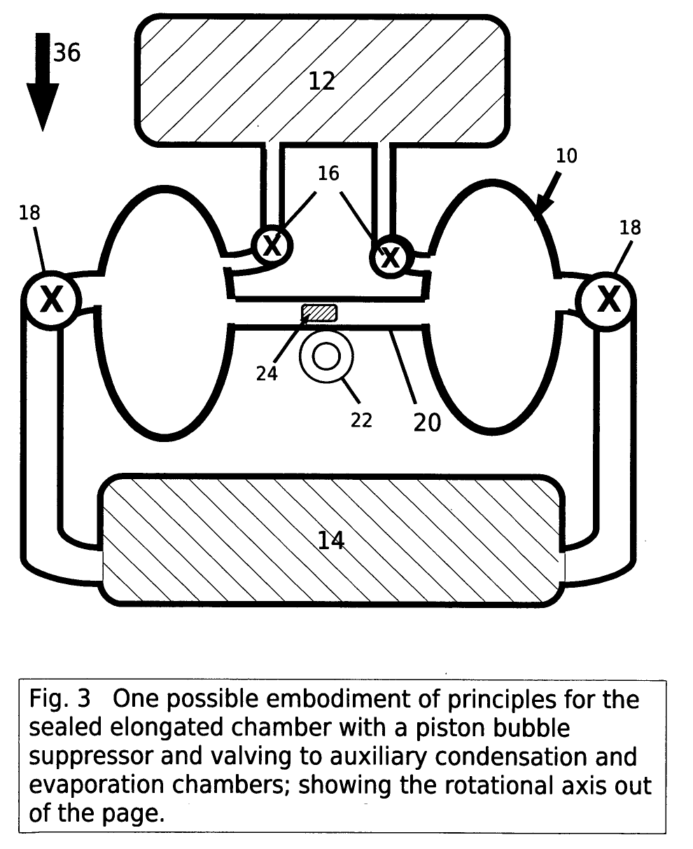

### FIG. 3—Additional Embodiment

The operation of the elongated chamber 10 and valving is the same as that for FIG. 2. The control of the floating bubble is done by impeding vapor flow with the bubble control piston 24. This rocks like that in FIG. 2.

A similar modification to that in FIG. 2 is needed to operate this embodiment as a heat engine (not shown). This will provide pure distillate, mechanical energy, and low grade waste heat.

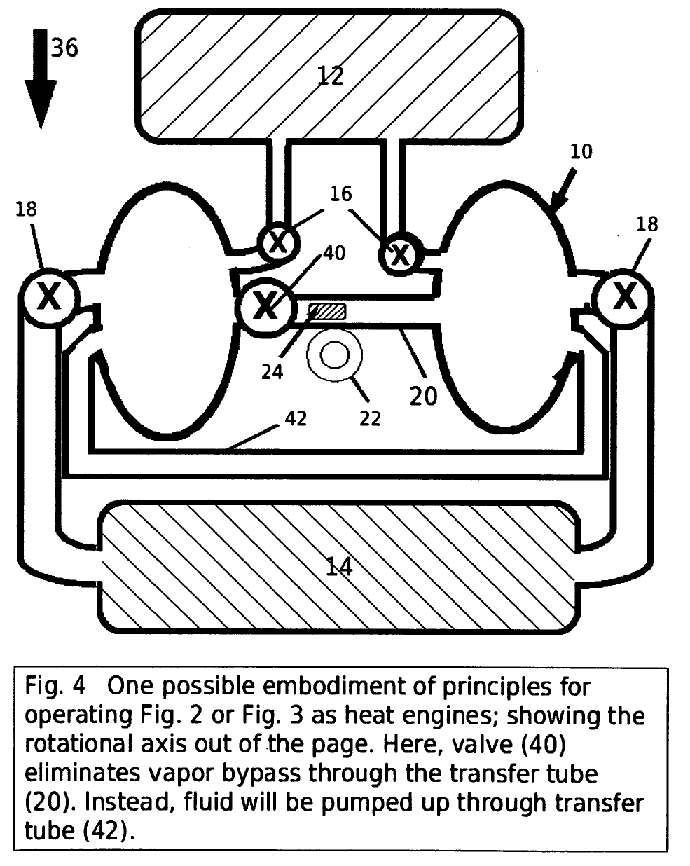

### FIG. 4—Additional Embodiment Detail

One possible embodiment of principles for operating FIG. 2 or FIG. 3 as heat engines; showing the rotational axis out of the page. Here, valve 40 eliminates vapor bypass through the transfer tube 20. Instead, fluid will be pumped up through transfer tube 42 during the power strokes.

I claim:

1. a mechanical distillation system comprising:
(a) a sealed elongated chamber structurally and materially capable of withstanding fluid chemical aspects and operating pressures.
(b) means for limiting vapor bubble back flow along the said sealed elongated chamber upon inverting or reorienting cycles.
(c) said sealed elongated chamber filled largely with a fluid, fluids, entrained solids, or distillate.
(d) a means for said inverting or reorienting said sealed elongated chamber within an accelerated force field such as gravity, centrifugal force, or other.
(e) vapor blocking means for allowing evolved vapor outflow only during exhaust and inflow only during vapor evolution when necessary.
whereby vapor is evolved and then compressed during the said inverting or reorienting cycles allowing distillate separation along with the latent heat content while utilizing or producing mechanical energy efficiently.

2. The distillation system of claim 1 in which said inverting or reorienting the fluid with and within the said sealed elongated chamber such that the said accelerated force field acting on the higher potential energy volume of fluid will decrease the local pressure within the said sealed elongated chamber volume to that below the vapor pressure of said higher potential energy volume of fluid or a component thereof due to flow of said fluid into the lower potential energy volume end of the said sealed elongated chamber without bubble back flow, causing evaporation and development within the said sealed elongated chamber of an evolved vapor volume which was sourced from evaporation within the said sealed elongated chamber or at least partially in an auxiliary evaporation chamber containing distilland whence latent heat of evaporation is sourced.

3. The distillation system of claim 1 in which transport of said evolved vapor volume before, after, or during said inverting or reorienting of said sealed elongated chamber yields vapor conduction by near laminar gas flow due to pure vapor state within the said sealed elongated chamber and through said vapor blocking means whereby a separation of the distillate and latent heat is accomplished.

4. The distillation system of claim 1 in which said inverting or reorienting of the said sealed elongated chamber within the said accelerated force field such that said evolved vapor volume experiences increased hydraulic and so pneumatic pressure due to the greater fluid column pressure from the said higher potential energy volume of fluid to the said lower potential energy volume from the act of said inverting or reorienting the said sealed elongated chamber whereby condensation with attendant release of latent heat in the higher pressure end of the said sealed elongated chamber or at least partially in the said auxiliary condensation chamber occurs.

5. The distillation system of claim 1 in which condensation of said evolved vapor volume in the inverted end of said sealed elongated chamber with said lower potential energy volume of fluid or within the said auxiliary condensation chamber is used to help drive the further evaporation of fluid or some component of the fluid in the said higher potential energy volume of fluid end of said sealed elongated chamber or within the said auxiliary evaporation chamber which acquires a reduced pressure upon said inverting or reorienting in the said accelerated force field as the said evolved vapor volume condenses or is removed from the now said lower potential energy volume end of the said sealed elongated chamber so the system pressure is dropped by this volume condensation whereby the required mechanical energy to invert or reorient the said sealed elongated chamber is decreased.

6. The distillation system of claim 1 in which continuing cyclic said inverting or reorienting of said sealed elongated chamber within said accelerated force field to alternately evolve vapor and then condense such vapor with attendant said vapor blocking means to avoid flow back of evolved vapor into the said auxiliary evaporating chamber during increased pressure and to avoid vapor flow back from the said auxiliary condensing chamber during the low pressure duration of the cycles whereby a pulsating distillation from alternating evaporation and condensation volumes forming from alternate ends of the said sealed elongated chamber due to alternating potential energies for each end of said sealed elongated chamber due to said inverting or reorienting is caused.

7. The distillation system of claim 1 in which operation of this invention is in reverse wherein the said auxiliary evaporation chamber is heated providing greater pressure which is valved via said vapor blocking means to the said lower potential energy volume of said sealed elongated chamber to drive the fluid piston upwards against the said accelerated force field and driving the vapor within the upper said second sealed elongated chamber volume into the said auxiliary condensation chamber for condensation causing unbalance in the said sealed elongated chamber whereby the now higher potential energy volume of fluid is allowed to fall with attendant release of usable mechanical energy repeating cyclically.

8. The distillation system of claim 1 in which incorporation of an insulating, differing density, magnetic, conductive, or differing vapor pressure layer, surface, fluid, or particles into the said sealed elongated chamber to change vapor exchange properties so that evaporation or condensation of distillate increases by varying evaporation or condensation within the ends of the said sealed elongated chamber fluid piston whereby throughput of the distillate or latent heat separations are improved.

9. The distillation system of claim 1 in which said pulsating distillation operates continuously as long as feed fluid is supplied at the correct pressure with sufficient heat to maintain sufficient temperature to allow continued evaporation and wherein condensed fluids, incondensable gases, and latent heat are removed avoiding latent heat accumulations raising the condensation surface temperatures above the point where the vapor pressure of the compressed vapor is insufficient to condense or cooling the evaporation surface temperatures below that required for further evaporation.

10. The distillation system of claim 1 in which external heat exchange means in variable thermal communications with said sealed elongated chamber ends or as needed to the said auxiliary condensation chamber or said auxiliary evaporation chamber to remove the heat generated by condensation for use in heating, to supply heat to the evaporation for use as cooling, or to move the heat generated by condensation for use directly to augment evaporation to maximize distillate production.

11. The distillation system of claim 1 in which using the terrestrial or other gravitational potential gradient, a rotating frame of reference for centrifugal force field generation of a potential gradient, an inertial acceleration of the said sealed elongated chamber directionally and then altering this directional path in any way to produce a potential gradient, any electrostatic or magnetic fields imparting force to the material in said sealed elongated chamber, or any combination of these force generators for purposes of creating the necessary said accelerated force fields whereby pressure gradients within the said sealed elongated chamber for operation of the said mechanical distillation systems is provided.

12. The distillation system of claim 1 in which use of this said mechanical distillation system for any fluid mixtures, solutions, or combinations with varying partial pressures at at least one temperature with one or a series of these said sealed elongated chambers to be ganged or operated in series or parallel with or without attendant heat pump use for heating, cooling, or heat feedback to improve efficient evaporation or condensation for input mechanical, electrical, or other energy whereby fractional distillation or separation is obtained.

13. The distillation system of claim 1 in which operation occurs at any non solidifying temperature and pressure regime by applying the system pressure near the center of the said sealed elongated chamber to a value between the vapor pressure of the distillate at the surface temperature of the said higher potential energy volume of fluid and the pressure of the said lower potential energy volume of said sealed elongated chamber whereby stable operation of the distiller is allowed.

14. The distillation system of claim 1 in which this said mechanical distillation system provides a source of elevated or depressed temperature to a Sterling engine or other heat device utilizing the temperature separation provided by this device or augmenting other sources of elevated or depressed temperatures whereby distillation or efficient latent heat separation are produced in addition to or separately from other gains realized from such alternative processes.

15. The distillation system of claim 1 in which use of this said mechanical distillation system with a combination of fluid and solid, gas or other phase component to alter the effective density of the mixed column in the said sealed elongated chamber to alter the required column heights, pressures, or temperatures required to effect separations by said mechanical distillation system.

16. The distillation system of claim 1 in which a screw shaped said sealed elongated chamber with the rotating axis placed across the said accelerated force field for forming pressure which effects changes in pressure from low temperature vapor pressure to greater pressure in a continuous manner as it rotates to create the pressure difference required by said mechanical distillation system.

17. The distillation system of claim 1 in which a second sealed elongated chamber or a series thereof connected with or without thermal communication to and shaped similar to the said sealed elongated chamber to augment distillate production wherein the said second sealed elongated chamber receives the said evolved vapor volume through said vapor blocking means allowing said evolved vapor volume to flow from the lower said sealed elongated chamber pressure to the upper said second sealed elongated chamber volume with the decreased pressure from the greater column of fluid below the tube interconnect and upon said inverting or reorienting the distillate vapor inducted into the said second sealed elongated chamber will be further compressed and will condense within or in a said auxiliary condensation chamber allowing the induction of the vapor from the other end of the said second sealed elongated chamber at a lower pressure whereby the removal of vapor from the said sealed elongated chamber is augmented by the pressure reduction induced by the said second sealed elongated chamber.

18. The distillation system of claim 1 in which this invention operates alternately forward and backward to repeatedly distill the same fraction with detailed control of all chamber temperatures to serially purify the target distillate fraction to arbitrary quality allowing high purity separations, accurate analytical applications on variable partial pressure ranges, inherent isolation of dangerous substances, and other applications of the distilled pure products.
